(19) United States
(12) Patent Application Publication
(10) Pub. No.: US 2009/0121880 A1
(43) Pub. Date: May 14, 2009

(54) APPLICATORS AND APPARATUSES FOR APPLYING RADIO FREQUENCY IDENTIFICATION (RFID) TAGS

(75) Inventors: Terrence H. Joyce, JR., Lakeville, MN (US); William C. Egbert, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/938,576

(22) Filed: Nov. 12, 2007

(51) Int. Cl. G08B 13/14

(52) U.S. Cl. 340/572.8

(57) ABSTRACT

Applicators, apparatuses, and methods for applying a radio frequency identification (RFID) tags to items, particularly books and other library items.

### TECHNICAL FIELD

The present invention relates to applicators, apparatuses, and methods for applying a radio frequency identification (RFID) tags to items, particularly books and other library items.

### BACKGROUND OF THE INVENTION

Radio-Frequency Identification (RFID) technology has become widely used in virtually every industry, including transportation, manufacturing, waste management, postal tracking, airline baggage reconciliation, and highway toll management. RFID systems are often used to prevent unauthorized removal of articles from a protected area, such as a library or retail store.

An RFID system often includes an interrogation zone or corridor located near the exit of a protected area for detection of RFID tags attached to the articles to be protected. Each tag usually includes information that uniquely identifies the article to which it is affixed. The article may be a book, a manufactured item, a vehicle, an animal or individual, or virtually any tangible article. Additional data as required by the particular application may also be provided for the article.

To detect a tag, the RF reader outputs RF signals through an antenna to create an electromagnetic field within the interrogation corridor. The field activates tags within the corridor. In turn, the tags produce a characteristic response. In particular, once activated, the tags communicate using a pre-defined protocol, allowing the RFID reader to receive the identifying information from one or more tags in the corridor. If the communication indicates that removal of an article has not been authorized, the RFID system initiates some appropriate security action, such as sounding an audible alarm, locking an exit gate or the like.

One example of suitable RFID tags for application to books and other library materials is commercially available from 3M Company as 3M™ RFID Tags. Such tags commonly have dimensions of 1.88″×2.25″ (48 mm×57 mm).

In addition, many stores and other places of business have installed electronic article surveillance systems (EAS) for controlling unauthorized removal of articles. Such systems typically use a single or dual status ferromagnetic marker attached to an article with systems placed at exits which detect the markers and sound an alarm.

Special EAS systems have been developed for libraries and bookstores. The markers and attachment methods used with clothing and many other articles cannot be easily attached to books without damaging the book. EAS ferromagnetic markers for use in books are typically long narrow strips that are manually inserted between two opposing pages of a book, close to and extending substantially parallel to the binding. One example of an EAS ferromagnetic marker is disclosed in U.S. Pat. No. 5,331,313, assigned to Minnesota Mining and Manufacturing Company (now 3M Company). Each side of the EAS marker is typically coated with an adhesive to secure the marker to the book pages. When properly placed, the EAS markers are difficult to visually detect, difficult to remove, and do not detract from the reader's ability to read and enjoy the book. The EAS markers must be deactivated when articles marked with them are checked out of libraries or purchased in stores so that an alarm does not sound.

One system for inserting the EAS markers described above in a covert manner is disclosed in U.S. Pat. No. 5,833,763, assigned to Minnesota Mining and Manufacturing Company (now 3M Company). One system that is currently sold by 3M that is very similar to the system described in the '763 patent is 3M™ Tattle-Tape™ Application System 611. This system can be used to automatically dispense 3M™ Tattle-Tape™ Security Strips R2, which are EAS ferromagnetic markers provided in a roll format, and applying such EAS markers between opposing pages or into the spine of a book.

### SUMMARY OF THE INVENTION

One aspect of the present invention provides a radio frequency identification (RFID) tag application apparatus. This RFID tag application apparatus comprises: a first jaw and a second jaw, where the first and second jaws are moveable between an open and close position; an RFID tag positioned between the first and second jaws when the jaws are in the open position; and an RFID tag applicator positioned between the first and second jaws, where the first and second jaws applies the RFID tag to the RFID tag applicator when the jaws are in the closed position, where after the first and second jaws have moved between the open and closed positions to apply the RFID tag to the RFID tag applicator, the RFID tag is functional.

Another aspect of the present invention provides an applicator for applying a radio frequency identification (RFID) tag to an item. This applicator comprises: a handle portion; a planar applicator portion attached to the handle portion, where the planar applicator portion includes a first recess on a first surface to provide protection to an integrated circuit of an RFID tag, and where the planar applicator portion comprises a non-conductive material.

Another aspect of the present invention provides an apparatus for removing a radio frequency identification (RFID) tag from a roll of RFID tags on a liner. The apparatus comprises: a first jaw and a second jaw, where the first and second jaws are moveable between an open and close position; and an RFID tag positioned between the first and second jaws, where the RFID tag comprises a substrate, an antenna on at least one surface of the substrate, an integrated circuit electrically coupled to the antenna, and at least one adhesive layer on at least one surface of the RFID tag, where the first jaw includes a recess to provide protection to an integrated circuit of the RFID tag, where the integrated circuit of the RFID tag is aligned with the recess, and where after the first and second jaws have moved between the open and closed positions, the RFID tag is functional.

Another aspect of the present invention provides a method for automatically removing an radio frequency identification (RFID) tag and applying the RFID tag to an RFID tag applicator. This method comprises the steps of: providing a roll of RFID tags attached to a liner where the RFID tags comprise a substrate, an antenna on at least one surface of the substrate, an integrated circuit electrically coupled to the antenna, and at least one adhesive layer on at least one surface of the RFID tag; providing a first jaw and a second jaw, where the first and second jaws are moveable between an open and close position, where the first jaw includes a recess to provide protection to the integrated circuit of the RFID tag (while applying the RFID tag to the RFID tag applicator); peeling one of the RFID tags away from the liner and inserting the RFID tag between the first and second jaw while the jaws are in the open position, such that the integrated circuit of the RFID tag is aligned with the recess of the first jaw; inserting an RFID tag applicator between the first and second jaw adjacent the RFID tag; moving the first and second jaws the closed position to temporarily attach the RFID tag to the RFID tag applicator; moving the first and second jaws to the open position; and removing the RFID tag applicator with the RFID tag attached thereto, wherein the RFID tag is functional.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 illustrates a side sectional view of one embodiment of the RFID tag application apparatus;

FIG. 2 illustrates a top sectional view of the RFID tag application apparatus of FIG. 1;

FIG. 3 illustrates a perspective view of a book with an RFID tag of FIG. 3A inserted between opposing pages of the book;

FIG. 3A illustrates one embodiment of an RFID tag useful for insertion into books;

FIG. 4 illustrates an end view of a book with an RFID tag of FIG. 3A inserted into the spine of the book;

FIG. 5 illustrates a perspective view of one embodiment of a paddle type applicator convenient for use with the RFID tag application apparatus of FIG. 1;

FIG. 5A illustrates a view of the applicator of FIG. 5 taken along line 5A-5A;

FIG. 5B illustrates a view of an alternative embodiment of the applicator of FIG. 5 taken along line 5B-5B;

FIG. 5C illustrates a perspective view of the RFID tag of FIG. 3A attached to the applicator of FIG. 5;

FIG. 6 shows a side view of one embodiment of a bayonet type applicator convenient for use with the RFID tag application apparatus of FIG. 1;

FIG. 6A illustrates a perspective view of the RFID tag of FIG. 3A attached to the applicator of FIG. 6;

FIG. 7 shows a side sectional view of the jaws and the RFID tags on a liner with an end RFID tag partially separated from the liner, where the jaws are in the open position;

FIG. 8 shows a side sectional view of FIG. 7 illustrating the jaws in a closed position, where the end RFID tag and applicator of FIG. 5 are both gripped by the jaws;

FIG. 9 shows a side sectional view of FIG. 8 illustrating the jaws and the end RFID tag separated by the jaws and pressed onto the applicator of FIG. 5.

FIG. 10 illustrates a side sectional view of another embodiment of the RFID tag application apparatus; and

FIG. 11 illustrates a top sectional view of the RFID tag application apparatus of FIG. 10.

### DETAILED DESCRIPTION OF THE INVENTION

There has been a movement from using traditional bar codes to using radio frequency identification or “RFID” technology to address the limitations of optical barcodes. While inexpensive and effective, the optical bar code system has certain limitations. For example, bar codes must be visible, which limits the locations in which they may be placed, and bar codes can easily be obscured, either accidentally or intentionally. The range at which a detector can sense the bar code is also comparatively small. The bar code may also have to be appropriately positioned for detection. Also, because bar codes are often exposed to permit detection, the barcode is susceptible to damage that can result in detection failures. Lastly, multiple items must be processed one at a time. These constraints of bar code systems make them undesirable or inefficient for some applications, such as marking library media.

One application of RFID technology is in libraries, where a variety of items are tagged with an RFID tag to provide information about the item when it is checked out of the library or when it is checked back in. Some examples of items to be tagged in libraries include books, magazines, DVDs, CDs, VHS cassettes, and audiocassettes. It can be appreciated that for a library's systems to function effectively, all the items in a library collection preferably include an RFID tag. Previously, the RFID tags have been removed from a box or roll of RFID tags and manually inserted into the item, such as a book. Manual removal, location, and insertion of RFID tags in libraries may be acceptable when the collection is quite small, however manual insertion methods may not be acceptable with larger collections.

The RFID tags are typically manufactured in a roll form on a liner with an adhesive layer on both the front and back of the RFID tags to adhere to the pages of the book. The RFID tags may be provided individually by cutting individual tags from the roll. The process of removing the adhesive coated RFID tag from the liner and manually inserting and positioning each individual RFID tag is very laborious, expensive and time consuming for large collections.

In addition to time and expense involved with manual location and insertion, the quality of positioning each RFID tag may vary with hand placement. It is appreciated that if RFID tags having adhesive on both sides are placed on the page too far from the binding, it will be more difficult for the reader to turn the pages and the pages between which the RFID tag is inserted will not be sufficiently separated and may be difficult to read. Similar problems also occur should the RFID tag be placed into the book in a skewed or bowed manner. The removal and insertion of the RFID tags by hand may also unduly stress or otherwise damage the RFID tags. When this occurs, the RFID tags may not function or operate incorrectly after they have been applied to the item. When referring to the RFID tags as “functional,” as used herein, including the claims, it is meant that the RFID tag is capable of being interrogated successfully by an RFID reader or interrogator. For example, when a functional RFID tag is interrogated, the tag will successfully interpret and process commands received from the interrogation hardware and/or respond to requests for information by an interrogation device.

With some types of books, the binding includes a spine portion with a space between the cover and the spine. However, insertion of RFID tags into such a space is difficult as the space may only be accessed from the ends of the book. As the RFID tags have an adhesive placed thereon, it is difficult to slide the RFID tags into the end of the opening without the adhesive adhering to portions of the book at an undesirable position.

As access to books is somewhat difficult in some libraries, often requiring a ladder to reach, it is important that the books need not necessarily be transported to a central location for RFID tag insertion. Therefore it will be appreciated that if an insertion device is mobile so that it may be brought either into the aisles between book shelves or at least to different locations within the library, the work involved in transporting books is decreased.

The present invention provides a new and improved apparatus, an applicator, and methods for inserting RFID tags in items, for example, particularly between opposing pages of a book or into the spine of a book. It can be appreciated that such an applicator should provide for properly positioning and aligning an RIFD tag in a preferred location in a book in a rapid manner. The RFID tags are removed from a roll and then applied to an applicator member that can be easily inserted into a book for applying a RFID tag without damaging, bowing or misaligning the RFID tags. The applicator should be adaptable for inserting RFID tags into a variety of sizes and types of books and other items, such as DVDs or CDs. The apparatus and applicator of the present invention provide ways to temporarily apply RFID tags to the applicator by the apparatus without damaging or causing the RFID tag to become nonoperational or not functioning. The present invention addresses these as well as other problems associated with removal, insertion and placement of RFID tags used with books and other library items.

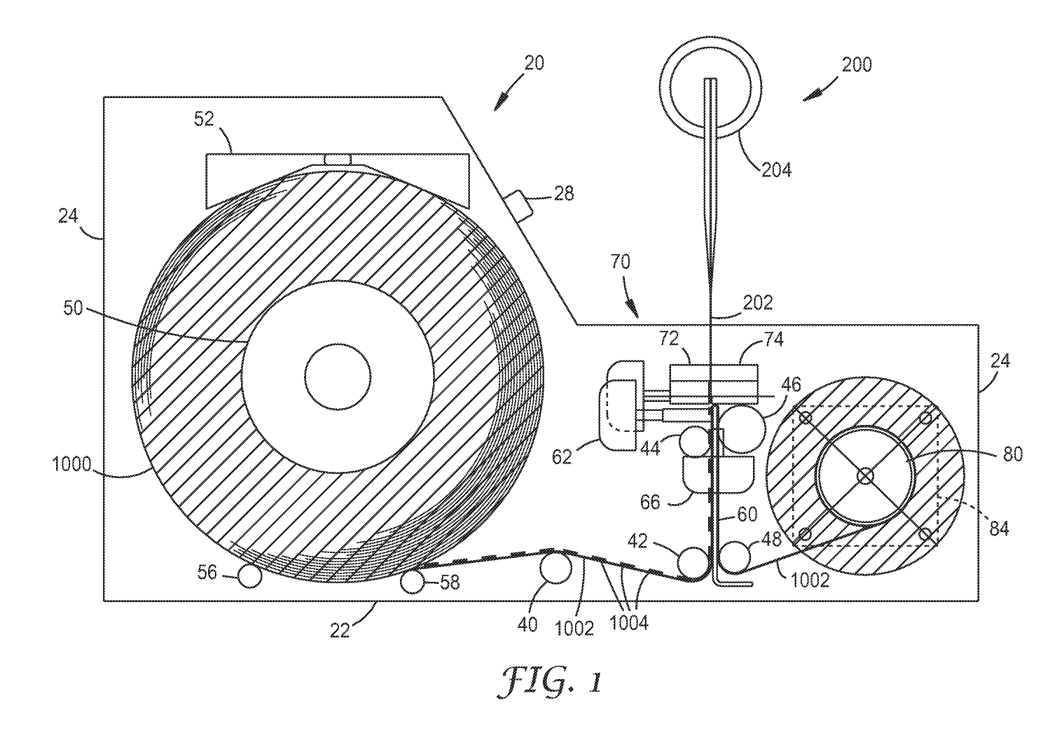

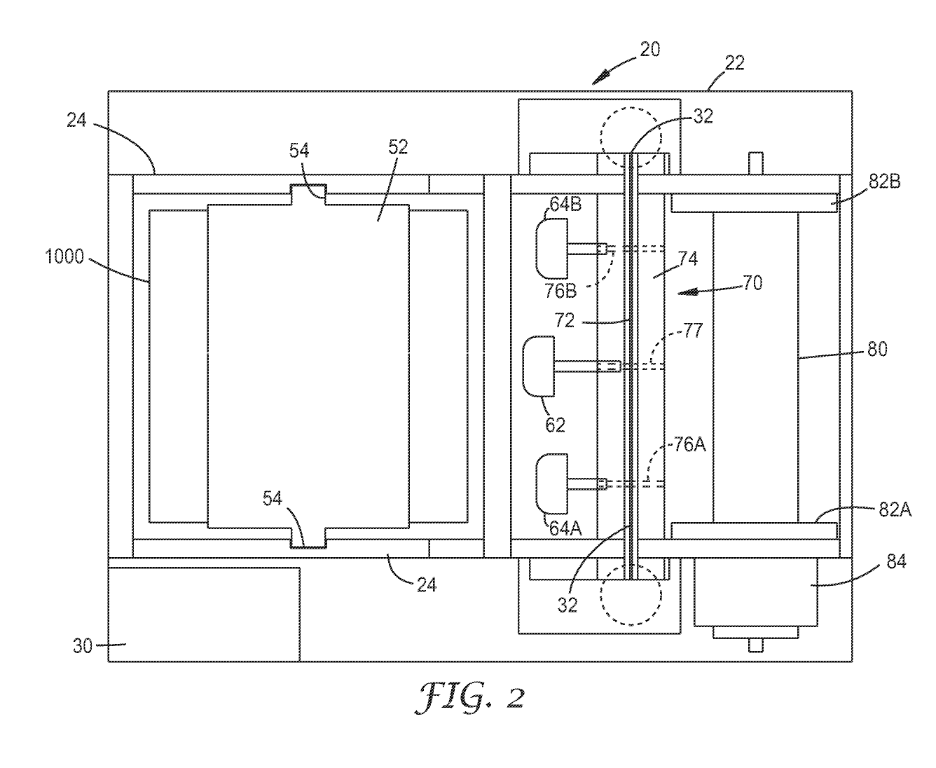

Referring now to the Figures, and in particular to FIGS. 1 and 2, there is shown a RFID tag application apparatus, generally designated 20. The RFID tag application apparatus 20 includes a housing 24 mounted on a base 22. The RFID tag application apparatus 20 may also include a battery or other power supply (not shown) and may include a display panel, screen or ready light 28, depending on user needs. In addition, a central processor or control circuitry 30 operates the various mechanisms associated with the RFID tag application apparatus 20, as explained hereinafter. A slot 32 is formed in the top and sides of the housing 24 providing access for applicators to the endmost RFID tags.

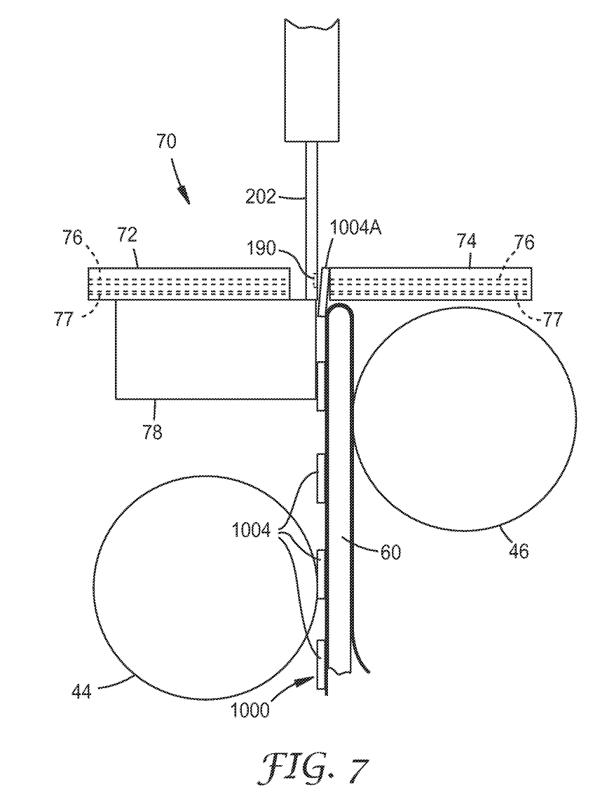

As shown in FIGS. 1 and 2, a supply spool 50 supports a roll 1000 of RFID tags. In one particularly suited embodiment, the RFID tags includes adhesive covered RFID tags 1004 mounted to a liner 1002. Each RFID tag 1004 is separate from the next adjacent RFID tag, as shown most clearly in FIGS. 7-9. The adhesive layer on the faces of the RFID tags generally creates a connective layer between the tags 1004 and the liner 1002. For some applications, the roll 1000 has adhesive applied to only one face, as explained hereinafter. The roll 1000 is supported on rods 56 and 58 which provide for feeding the RFID tags out in a very simple manner, as shown in FIG. 1. A weight 52 engages vertical slots 54 in the housing 24, shown in FIG. 2, and provides tension against the roll 1000 so that it does not over-rotate and feed out too much material.

The RFID tags 1004 on liner 1002 are pulled through the application apparatus 20. The liner 1002 is wound onto a take-up reel 80 which is driven by a motor 84. As shown in FIG. 2, alignment disks 82A and 82B at the ends of the take-up reel maintain the liner 1002 in proper alignment. The length of RFID tags on a liner is guided through the apparatus on guide rollers 40, 42 and 44 to a peel bar 60, shown in FIG. 1. Following removal of the RFID tags 1004 at the peel bar, the liner is directed over guide rollers 46 and 48 to the take-up reel 80.

Referring now to FIG. 7, a jaw assembly 70 includes an alignment bar 78 and a first jaw 72 and a second jaw 74, movable between an open and a closed position, as explained hereinafter. As shown in FIG. 2, solenoids 64A and 64B provide for clamping the jaws 72 and 74 together onto an applicator member, as explained below. Sensors 76A and 76B detect the presence of each end of an applicator member for controlling actuation of the solenoids 64A and 64B. Sensor 77 detects the presence of a RFID tag in a ready position intermediate the jaws 72 and 74, as explained below. In addition, as shown in FIGS. 1 and 2, a retaining solenoid 62 engages the liner so that an end RFID tag 1004A may be removed, as explained hereinafter. The jaw assembly 70 is vertically lifted for RFID tag separation by solenoids 66A and 66B, as explained below.

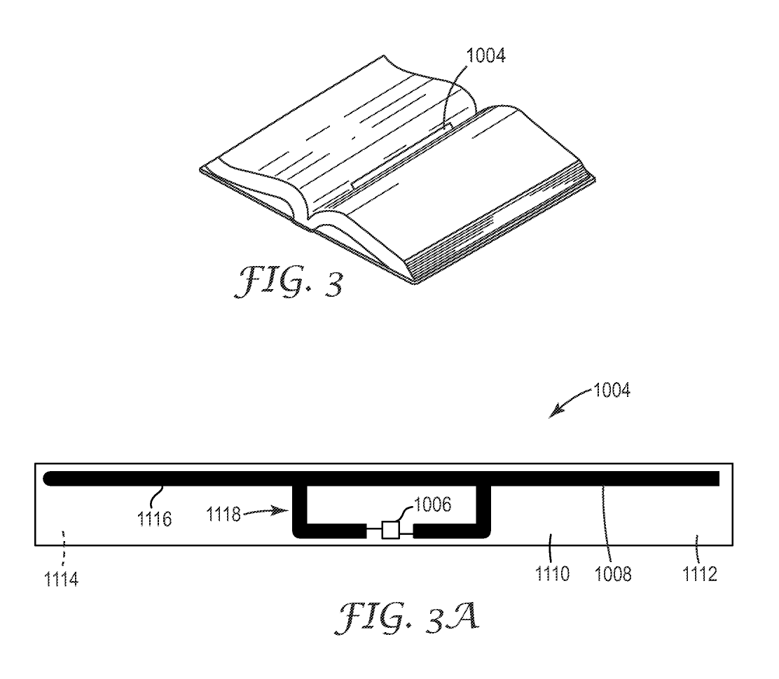

FIG. 3A is a schematic diagram illustrating an exemplary RFID tag useful with the RFID tag application apparatus 20 and the applicator 200, which is discussed in more detail below. FIG. 3A is an RFID tag 1004 with an antenna 1008. In the illustrated embodiment, the antenna 1004 is a modified dipole antenna. However, other types of RFID antennas may be used. The antenna 1004 is electrically coupled to an integrated circuit (IC) 1006, in the form of a chip, on a substrate 1110. In one embodiment, the antenna 1008 may be located on a first side of substrate 1110 and IC chip 1006 may be located on a second side of substrate 1110. In this case, feed points may electrically couple the antenna 1008 to IC chip 1006 using one or more vias or crossovers that extend through substrate 1110. Alternatively, in the illustrated embodiment, the antenna 1008 and IC chip 1006 may be located on the same side of substrate 1110. IC chip 1006 may include firmware and/or circuitry to store within RFID tag 1004 unique identification and other desirable information, interpret and process commands received from the interrogation hardware, respond to requests for information by an interrogation device and to resolve conflicts resulting from multiple tags responding to interrogation simultaneously. Optionally, IC chip 1006 may be responsive to commands (e.g., read/write commands) for updating the information stored in an internal memory as opposed to merely reading the information (read only).

In the illustrated embodiment, antenna 1008 includes a straight antenna segment 1116 coupled to a conductive loop segment 1118 disposed on substrate 1110. In other words, modified dipole antenna may be viewed as a straight dipole antenna with loop segment 1118 added. Straight segment 1116 and loop segment 1118 may be disposed on substrate 1110 using any of a variety of fabrication techniques including chemical vapor deposition, sputtering, etching, photolithography, masking, printing and the like. In one preferred embodiment, the antenna 1008 is configured to operate in an ultra high frequency (UHF) band of the radio spectrum. However, the RFID may be configured to operate in other frequency bands of the radio spectrum, such as high frequency.

Integrated circuits suitable for use in IC chip 1006 of RFID tag 1004 include those available from Texas Instruments located in Dallas, Tex., ST Microelectronics located in Geneva, Switzerland, Impinj, Inc. located in Seattle, Wash., among others.

In one embodiment of the RFID tag 1004, at least one layer of adhesive 1112 covers most of the substrate 1110, IC chip 1006 and antenna 1008. In another embodiment, the RFID tag 1004 could also include a second layer of adhesive on the opposite side of the substrate. An RFID tag 1004 that is coated with adhesive on both sides of the tag is useful for inserting between adjacent pages of a book or magazine.

One suitable RFID tag 1004 is disclosed in U.S. patent application Ser. No. 11/870789, “RFID Tag with Modified Dipole Antenna,” (Joyce et al.).

In one particularly suited embodiment for application to books and magazines, the antenna 1008 and IC chip 1006 are designed to fit within a rectangular-shaped substrate.

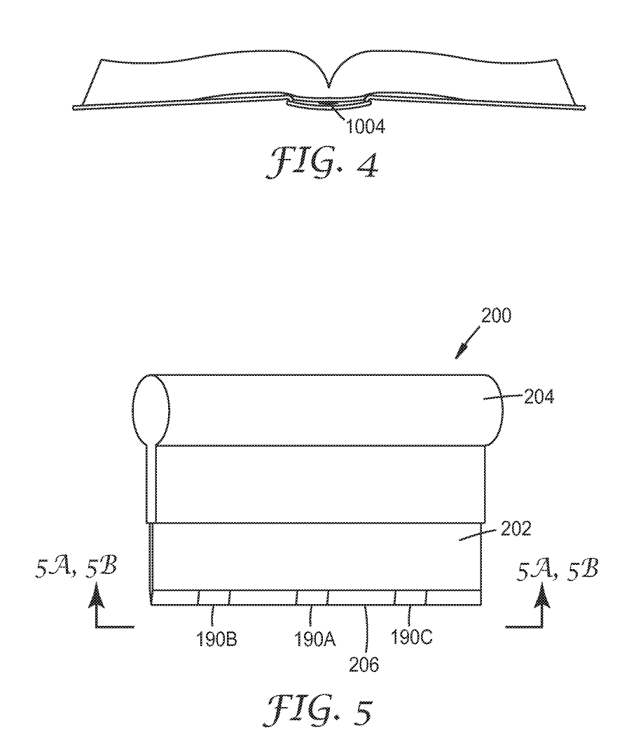

FIGS. 3 and 4 are schematic diagrams illustrating an RFID tag 1004 attached to an article. In the example of FIGS. 3 and 4, the article is a book. The book includes a cover, a spine and a plurality of pages. Cover may be a hard cover or a soft cover. In the examples illustrated in FIG. 3, RFID tag 1004 is placed within book on an inside portion of spine or between adjacent pages. The gutter is an area near spine of the book where one edge of each of the plurality of pages of the book is bound into the binding of book. RFID tag 1004 is placed in the gutter near the spine of the book. RFID tag 1004 may be attached to the inside portion of spine or between adjacent pages with the planar application portion 202 of the applicator 200, described in more detail below. For example, RFID tag 1004 may include an adhesive layer on one or both sides that may be attached to the spine or between adjacent pages.

RFID tag 1004 has dimensions that allow the tag to be both covert and not easily blocked from an interrogation signal by the hand or other body part of a person. RFID tag 1004 has a width that permits the RFID tag to be placed covertly along the inside portion of spine of most books, even books with relatively few pages. As described above, RFID tag may have a width of less than 10 mm (less than approximately 0.4 inches), and more preferably a width of less than 7 mm and even more preferably a width of less than approximately 3 mm. RFID tag 1004 has a length that permits RFID tag 1004 to be interrogated even when a hand of a person is placed over spine of book. In other words, the length of the RFID tag 1004 is configured such that an antenna of RFID tag 1004 extends beyond the hand of an average-sized person holding the book by the spine on or near a geometric centerline of book, thus preventing blocking of the interrogation signal to RFID tag 1004. As described above, RFID tag 1004 may have a length of greater than 100 mm (approximately 4 inches), and more preferably between 125 mm and 140 mm (approximately 5 to 5.5 inches), and even more preferably between 130 mm and 135 mm.

RFID tag 1004 may further serve as an electronic label for identification purposes such as for collecting cataloguing and circulating (check-out and check-in) information for the book, location information for the book or other identification and/or status information associated with the book. In other words, RFID tag 1004 may also be interrogated by other interrogation readers, such as handheld readers, desktop readers, and shelf readers to collect additional information. Although RFID tag 1004 of FIGS. 3 and 4 is shown attached to the book, RFID tag 1004 may be attached to other articles that may be located within library, such as magazines, files, laptops, CDs and DVDs.

FIG. 4 is schematic diagram illustrating an RFID tag 1004 attached to an article. Like FIG. 3, the article illustrated in FIG. 4 is a book. In the illustrated embodiment, RFID tag 1004 of FIG. 3A is located within the spine of a book. The gutter is an area near spine of the book where one edge of each of the plurality of pages of the book is bound into the binding of book. RFID tag 1004 is placed in the gutter near the spine of the book.

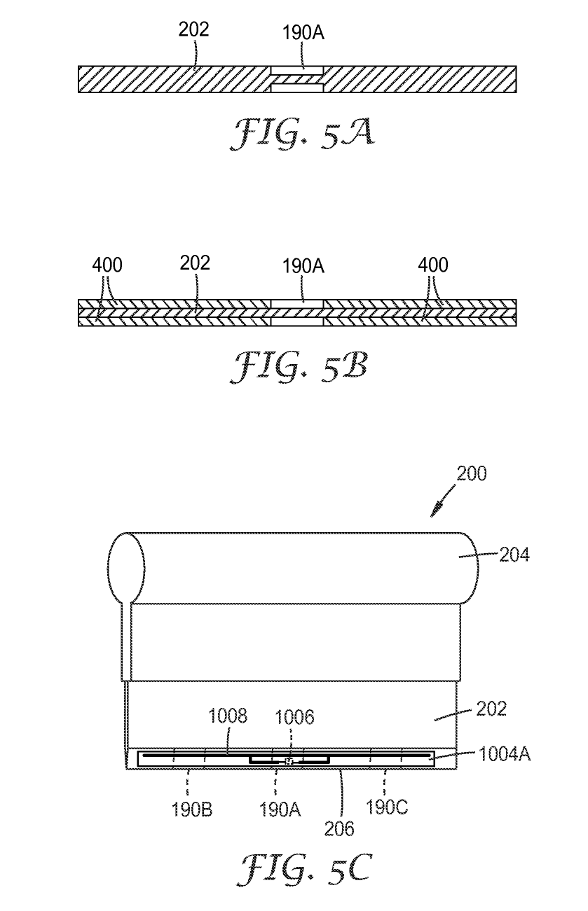

According to the present invention, the separated RFID tags are pressed onto an applicator for insertion into a book. One embodiment of a suitable applicator is illustrated in FIG. 5. This first embodiment of an applicator is a paddle type applicator 200. The paddle type applicator 200 includes a planar applicator portion 202 and a handle portion 204. The paddle type applicator 200 is designed to insert into slot 32 in the housing 24, shown in FIGS. 1 and 2, which opens to both the side and the top of the housing. The slot 32 provides for receiving and aligning the paddle type applicator 200 from above.

A RFID tag is placed parallel to a bottom edge 206 of the applicator portion 202 and spaced slightly from the bottom edge 206, as illustrated FIG. 5c. This placement provides for insertion of the paddle type applicator 200 into the book between opposing pages to place the RFID tag in an aligned position, as shown in FIG. 3. In one embodiment of the applicator 200, this placement also provides for aligning the IC chip 1006 of the RFID tag 1004 with a specially designed recess 190 in the planar portion 202 of the applicator 20. The recess 190 provides protection for the delicate IC chip 1006, when the RFID tag 1004 is applied to the applicator 200 by the jaws 72, 74 of the apparatus 200, as illustrated in FIGS. 7-9. But for the recess of this embodiment, the IC chip 1006 would be crushed between the jaws 72, 74, rendering the RFID tag 1004 as inoperable or not functioning. Prior art applicators for EAS tags, such as those illustrated in U.S. Pat. No. 5,833,763 or the 3M™ Tattle-Tape™ Application System 611 did not worry about what kind of pressure or force the EAS markers experienced when they were applied to applicators. This was not necessary because, as discussed above, the EAS markers being made of ferromagnetic materials, specifically a kind of metal, may be subjected to most pressures without rendering the EAS markers inoperable or not functioning.

Preferably, the RFID tag is spaced downwardly slightly from the bottom edge 206, such that when applying the RFID tag to a book, for example, the edge of the RFID tag is able to be positioned even further into the gutter of the book or between adjacent pages.

FIGS. 5A and 5B illustrate two examples of how the recess 104 may be formed on the planar portion 202. In FIG. 5A, recess 190 may be formed into the material of the planar portion 202. Alternatively, as illustrated in FIG. 5B, recess 190 may by formed by applying material 400 on the planar portion 202, thus forming a gap between the material which provides the recess 190. Preferably, the material used to form planar portion 202 and material 400 includes non-conductive materials. More preferably, planar portion 202 and material 400 consists only of non-conductive materials. Non-conductive materials are preferable for applications with RFID tags because it is difficult to interrogate the IC chip of the RFID tags when the tags are adjacent to conductive materials, such as metal. Examples of suitable non-conductive materials for planar portion 202 and material 400 include plastic or plastic laminate

FIGS. 5A and 5B also illustrate an alternative embodiment of planar portion 202, where the applicator 200 includes a second recess 190D. The second recess 190D is located directly opposite the first recess, as illustrated. However, the second recess could be located opposite and offset from the first recess. A second recess is convenient such that a user may use either side of the applicator 200 when inserting it into the apparatus 20. The applicator 200 may also include a plurality of recesses 190A, 190B, 190C on the same side of the planar portion 202, as illustrated in FIG. 5. As mentioned above, the recesses are sized and placed along the planar portion 202 to correctly align with the IC chip 1006 of the RFID tag 1004. As such, the IC chip 1006 may be placed at various positions relative to the RFID tag, or the RFID tags may even be staggered along a roll to provide some offset between adjacent tags. Regardless, the recess 190 should be designed into applicator 200 to correctly align the IC chips 1006 on the RFID tags 1004 provided by the apparatus 20, so that when the jaws 72, 74 come together to apply the RFID tag 1004 to the applicator 200, the surface of the jaws 72, 74, do not come into contact with or compress the IC chip 1006.

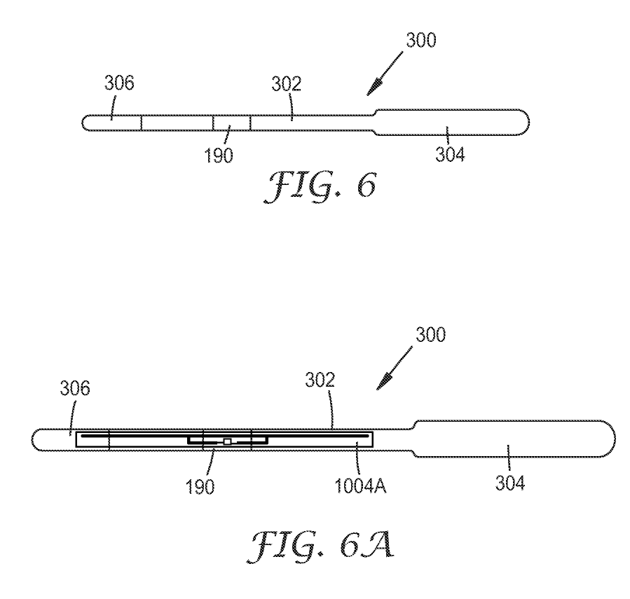

FIGS. 6 and 6A illustrate another embodiment of the applicator for applying RFID tags, a bayonet applicator 300. Applicator 300 includes a handle portion 304 and a blade portion 302, which preferably includes a tacky surface. In some uses, it is preferred that the RFID tag 1004 adhere only to the binding and not to the book cover over the binding. For such uses, the RFID tags 1004 have adhesive applied to only one face. The adhesive free face is pressed against the blade portion 302. The endmost RFID tag 1004A adheres to the tacky surface of the blade 302 and does not adhere to the non-stick surface of the jaws 72 and 74. However, the adhesive coated side of the RFID tag 1004A has sufficient tackiness to adhere to the binding of the book, rather than the blade 302, as shown in FIG. 4. The bayonet type applicator member 300 is configured so that the blade portion 302 may be inserted into the spine of the book, as shown in FIG. 4. The blade portion 302 inserts into the jaws 72 and 74 through the end of the slot 32, shown in FIGS. 1 and 2. Applicator 300 also includes the same recess 190 as the recess 190 was described in relationship to applicator 200 above, and may include a plurality of recesses 190 at different locations along blade 302. Therefore, the IC chip of RFID tag 1004 is aligned within the recess 190 to protect the IC chip during application of the RFID tag 1004 to the applicator 300, as illustrated in FIG. 6A.

Referring now to FIG. 7, it can be appreciated that the roll 1000 includes the RFID tags 1004 and an endmost RFID tag 1004A partially on the liner 1002 as the liner 1002 is directed around the peel bar 60 to help separate an RFID tag from the liner. Each of the RFID tags 1004 is illustrated as separate from the adjacent RFID tag, but the RFID tags may be adjacent one another. The endmost RFID tag 1004A may be separated by peeling the RFID tag from the liner and providing the individual RFID tags for application to the applicator 200.

In operation, the apparatus 20 is loaded with a roll 1000 of RFID tags 1004. The cover at the top of the apparatus 20 is open to allow access to the interior of the housing. The roll is simply placed onto the guide rods 56 and 58. The end of the roll 1000 is then fed out through the guide rollers 40, 42 and 48. The peel bar 60 is slidably removable through the bottom of the apparatus 20. When the RFID tag material is fed to the take-up reel 80, the peel bar 60 is inserted up between the rollers 42 and 48. When the peel bar 60 is fully raised, the RFID tag material is properly fed over the end of the peel bar 60 and between the guide rollers 44 and 46, as shown in FIG. 1. The end of the roll 1000 is attached to the take-up reel 80 by any of a number of methods. The width of the roll 1000 is preferably very precisely manufactured with very small width tolerances so that alignment is maintained by the disks 82A and 82B. When the roll 1000 has been emptied, the liner portion 1002 collected on the take up reel 80 may be removed and recycled or otherwise disposed.

In the preferred embodiment, the end of the roll typically has a starter portion so that the roll 1000 is fed out until the endmost RFID tag 1004A is advanced to the edge of the peel bar 60, as shown in FIG. 7. It can be appreciated that the weight 52 is placed so that its end portions engage the slots 54 so that the weight 52 simply rests on top of the roll 1000. The force of the weight 52 provides resistance to prevent the roll from over-rotating and feeding out too much material. Therefore, it can be appreciated that with the present invention, the proper roll advance is maintained by the drive motor 84 advancing the roll the width of one RFID tag as detected by the sensor 77, while the supply of RFID tags is maintained under tension by a simple weight. This provides for a very efficient and simple method for supplying RFID tags and maintaining the roll under proper tension.

As shown in FIG. 7, the liner 1002 is pulled over the peel bar 60 in a manner such that the endmost RFID tag 1004A is peeled away from the liner 1002 because the RFID tag is stiffer than the liner. The radius of the end of the peel bar 60 must be small enough that it prevents the individual RFID tags 1004 from bending to follow the radius, while allowing the more flexible liner 1002 to follow the radius, thereby separating the endmost RFID tag 1004A. It is also important that the distance between the peel bar 60 and the alignment bar 78 and the distance between the peel bar and the roller 46 not be too great so that the length of RFID tag material 1004 does not loop outward away from the peel bar 60 and misfeed or misalign. Additionally, it is preferred that the RFID tags 1004 include a stiffening paper or an additional polymer layer or thicker substrate to assist in peeling the tag from the liner in that the stiff RFID tag is less apt to bend around the peel bar. As the endmost RFID tag 1004A is peeled away from the liner 1002, it is positioned intermediate the jaws 72 and 74 and detected by the sensor 77. At this position, the apparatus 20 is substantially ready for placing a RFID tag onto an applicator 200, 300. The sensor 77 detects the presence of a RFID tag and the solenoid 62 is actuated to clamp the roll of RFID tag material 1004 uproll from the endmost RFID tag 1004A.

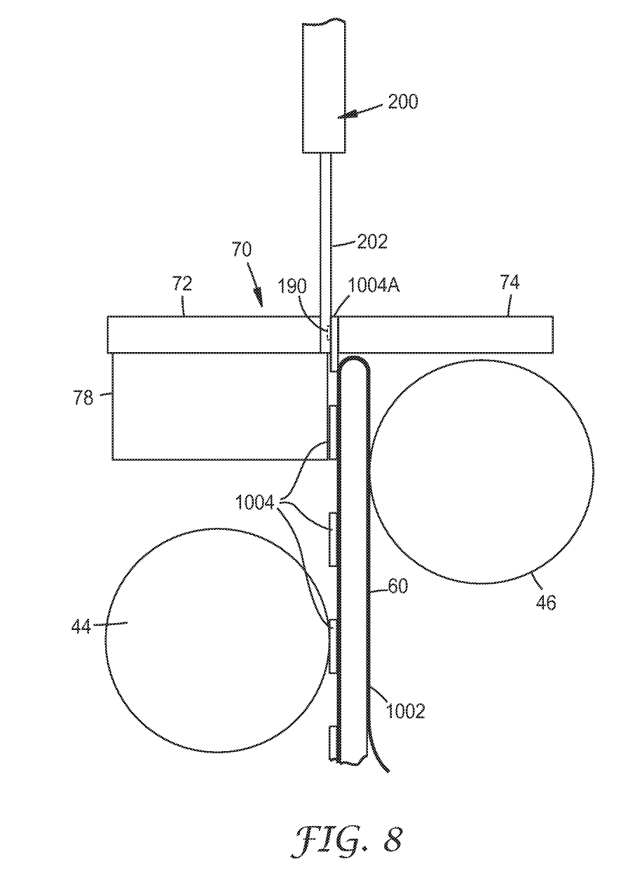

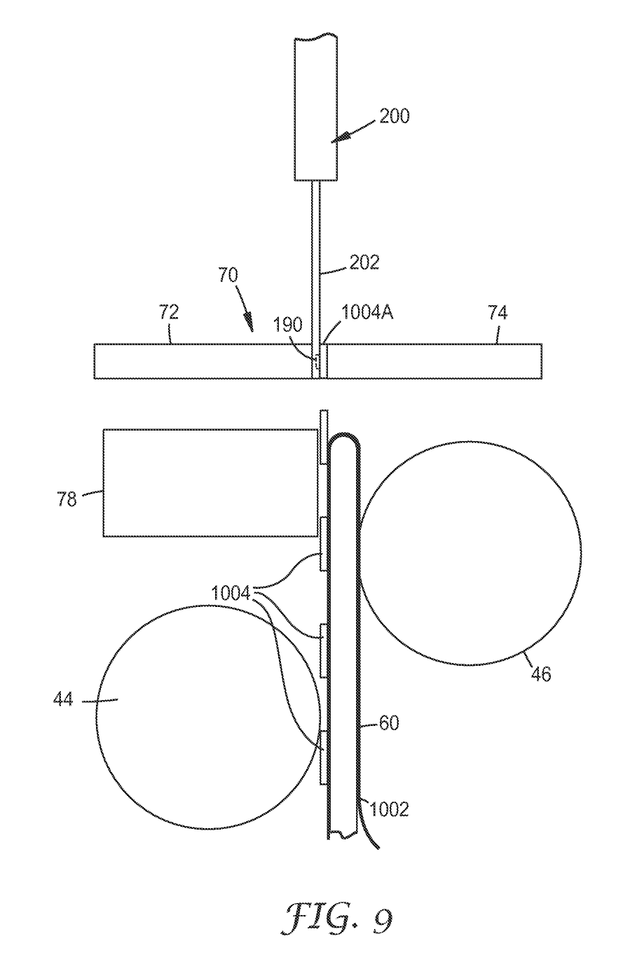

The applicator member, either 200 or 300, is inserted into slot 32 intermediate the jaws 72 and 74 and engaging the alignment bar 78. The optical sensors 76A and 76B detect the presence of the applicator 200 or 300 in the proper position on the alignment bar 78. Following a delay after detection of a properly aligned applicator, the solenoids 64A and 64B are actuated to close the jaws 72 and 74. The delay allows the holder of the applicator 200 or 300 to press the applicator fully against the alignment bar 78. The motion of the solenoids 64A and 64B clamps the endmost RFID tag 1004A against the applicator member 200 or 300 and intermediate the jaws 72 and 74, as shown in FIG. 8, where the jaws are in the close position. When the jaws 72 and 74 have been closed, the vertical solenoids 66A and 66B are actuated. In a preferred method, first one of the vertical solenoids 66A or 66B is fired and then the other, thus requiring less separation force to pull the end RFID tag 1004A away from the liner 1002. This vertical motion lifts the jaw assembly 70 with the applicator member 200 or 300 and a separated RFID tag 1004A clamped there between. During the motion of closing the jaws 72, 74 and during the vertical motion of pulling the end RFID tag 1004A by the jaw assembly away from the rest of roll of tags, the IC chip is carefully protected by the recess 190 on the applicator 200. The endmost RFID tag 1004A is lifted and separated from the rest of the RFID tags 1004 which are held by the solenoid 62, as shown in FIG. 9. When the jaw assembly 70 has been lifted and the endmost RFID tag 1004A separated, the jaw assembly 70 may be opened to release the applicator member 200 or 300 with the separated RFID tag 1004A applied thereto due to differences in the tackiness between the jaws 72 and 74 and the applicator 200 or 300. The take-up reel 80 is turned by the motor 84 to pull the next adjacent RFID tag 1004 into position of the endmost RFID tag 1004A and detected by the sensor 77, as shown in FIG. 7.

When the applicator 200 has received a RFID tag, the separated RFID tag 1004A is positioned near the bottom edge 206 of the applicator 200 and extending substantially parallel to the edge 206. To insert the RFID tag 1004A into a book, the paddle 200 is inserted to a depth between opposing pages of a book. The side of the paddle 202 having the RFID tag 1004A applied thereto is pressed against one of the pages to apply the RFID tag 1004A to a page, as shown in FIG. 3. It can be appreciated that the RFID tag insertion apparatus 20 provides for rapidly advancing RFID tags and for quickly and easily applying them to a paddle 200 or bayonet 300 for inserting a tag into the book and aligning the tag 1004 with the spine of the book.

The jaws 72 and 74 are typically coated with a plasma coating or other substantially non-stick surface, so that the difference in the adhesiveness of the surfaces will transfer the adhesive covered RFID tag 1004A from the jaws 72 and 74 to the paddle applicator 200 or blade applicator 300, and from the applicator to the pages of the book. In uses wherein the RFID tags 1004 have adhesive applied to only one side, the blade 302 or applicator portion 202 includes a tacky surface for adhering to the non-adhesive coated side of the RFID tags. However, the non-stick surface of the jaws 72 and 74 prevents the separated RFID tag 1004 from adhering to the jaws so that the RFID tag 1004 transfers to the blade 302 or applicator portion.

If the RFID tags 1004 are being inserted between the pages of a book, the paddle 200 is preferably utilized. The applicator portion 202 is inserted between the pages with the edge 206 pressed against the spine or in the gutter. The side of applicator portion 202 retaining the RFID tag 1004 is pressed against one of the pages, thereby transferring the RFID tag 1004 to the book.

If the RFID tags are being inserted into the spine of the book, the bayonet type applicator 300 is preferably utilized. When the apparatus 20 is ready with the RFID tag 1004 and the jaws 72 and 74 positioned as shown in FIG. 7, the bayonet type applicator 300 is inserted with the handle 304 extending from the side of the slot 32 and the blade 302 positioned intermediate the jaws 72 and 74. When the sensors 76A and 76B detect the presence of the blade 302 in the correct receiving position, the solenoids 64A and 64B are actuated to clamp the jaws 72 and 74 against the endmost RFID tag 1004A and the blade 302 of the bayonet type applicator 300. The vertical solenoids 66A and 66B then pull the clamped jaw assembly 70 and the bayonet applicator 300 upward, thereby separating the endmost RFID tag 1006. When the endmost RFID tag 1004A has been pulled away from the next adjacent RFID tag 1004, the jaws 72 and 74 open and the bayonet type applicator 300 may be removed with a separated RFID tag 1004A applied thereto. The blade 302 of the applicator 300 may then be inserted into the spine of a book and the RFID tag 1004A pressed against the binding for insertion into the spine, as shown in FIG. 4. Since the spine is more receptive to the adhesive applied to the RFID tag 1004, the RFID tag transfers from the blade 302 to the book. As discussed above, during the application of the RFID tag to the applicator 300 and its subsequent application to the spine of the book, the IC chip is protected with the recess 190.

In a first method, the applicator blade 302 is inserted intermediate the jaws 72 and 74 so that an end portion of the separated RFID tag 1004 adheres to the tackier portion 306 of the bayonet applicator. In this manner, the RFID tag 1004 adheres slightly more at the extended end of the blade 302. When the blade 302 is inserted into the spine of the book, the end of the RFID tag 1004 adhering to the tackier portion 306 tends to pull the rest of the RFID tag into the spine as the leading end is harder to release. When the RFID tag 1004 is inserted to the desired insertion position, the blade 302 is pressed against the spine while insertion continues, after which the blade 302 is lifted from the spine. This motion breaks the grip on the end portion 306 and the remainder of the blade 302 and transfers the RFID tag 1004A cleanly from the applicator 300 and adheres the RFID tag 1004 to the book spine. This method avoids some transferring problems associated with just pressing the blade 302 against the spine of the book, which tends to press the RFID tag 1004 harder against the applicator and may make transferring the RFID tag 1004 to the spine of the book more difficult.

In a second method, wherein RFID tags 1004 with adhesive applied to only one face are utilized, the blade 302 is inserted in a similar manner. However, the tackiness of the adhesive on the one face of the RFID tag 1004 is greater than the tackiness of the blade 302. Therefore, when the RFID tag 1004 is pressed against the binding, the RFID tag 1004 transfers from the bayonet 300 to the book binding.

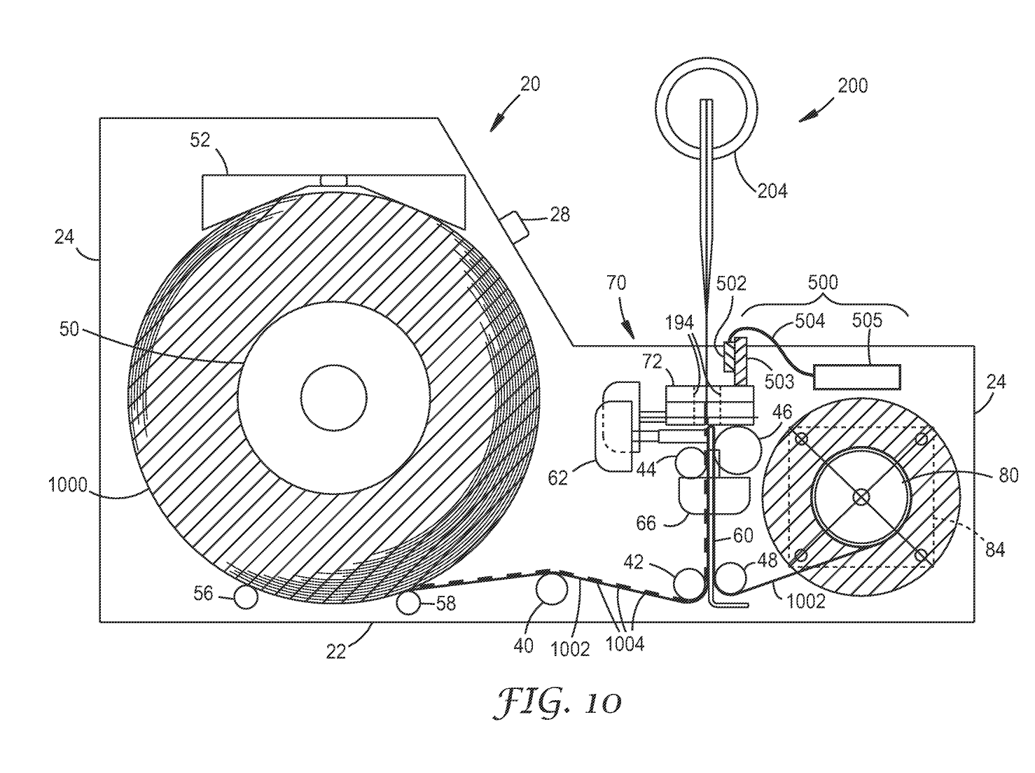

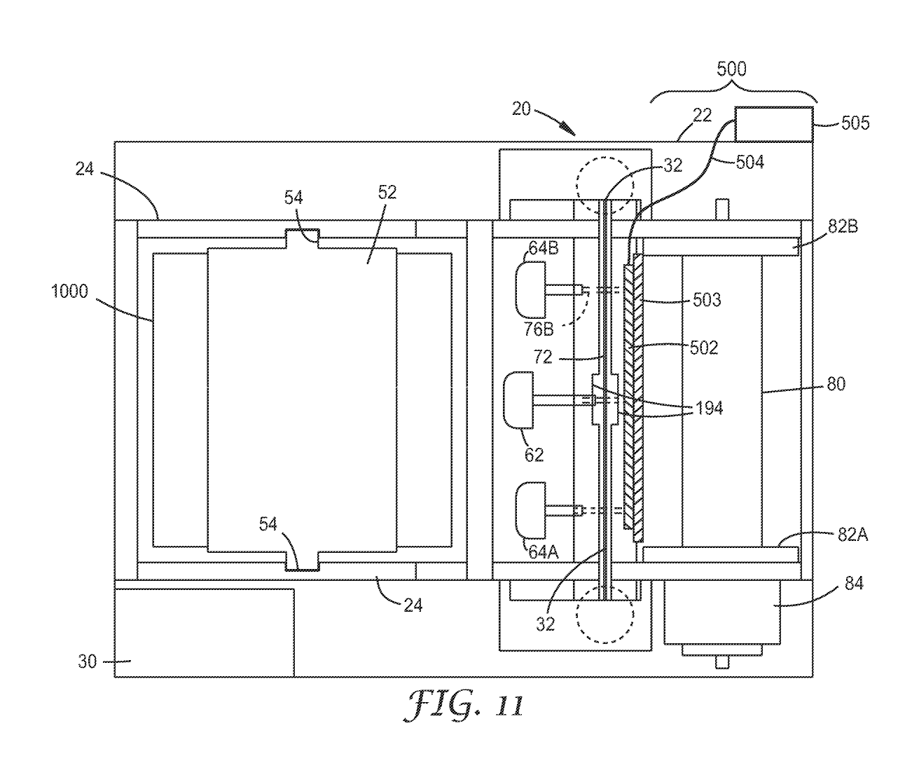

FIGS. 10 and 11 illustrate an alternative embodiment of RFID tag application apparatus 20. Apparatus 20 of FIGS. 1 and 2 is exactly like apparatus 20 illustrated in FIGS. 1 and 2, except that instead of the recesses residing on the applicator 200, 300 they instead reside on the jaws 72, 74 themselves. The first jaw 72 includes a recess 194. In addition, second jaw 74 may include a recess 194, to allow flexibility as to which side the RFID label is applied to the applicator 200, 300. Similar to recess 190, recess 194 is designed to protect or provide some relief to the delicate IC chip that is on the RFID tag 1004A, as the RFID tag is applied to the applicator 200, 300. Similar to recesses 190 illustrated in FIGS. 5A and 5B, recess 194 may be formed be formed into the material of the jaws 72, 74. Alternatively, as illustrated in FIG. 5B, recess 194 may by formed by applying material on the jaws 72, 74, thus forming a gap between the material which provides the recess 194. As yet another alternative, the recess could additionally be partially or completely filled with a compressible material, which could assist in protecting the delicate IC chip.

In addition, apparatus 20 illustrated in FIGS. 10 and 11 differs from apparatus 20 illustrated in FIGS. 1 and 2 in that apparatus 20 includes an interrogator 500 for reading and/or writing information to the RFID tag. Preferably, the interrogator 500 is positioned adjacent the first and second jaws 72, 74, which is convenient for testing the RFID tag to make sure it is still functioning after the RFID tag has been applied to the applicator 200, 300 or convenient to read and/or write information to the RFID tag just prior to applying the tag to an item. The item specific information could be written to the IC chip of the RFID tag just prior to applying the tag to an item, thus eliminating potential errors. Interrogator 500 is illustrated as including an RFID antenna or a microstrip structure 502, an antenna or microstrip structure support 503, interrogator electronics 505 and a cable 504 connecting the electronics 505 to the antenna or microstrip structure 502. One example of a suitable interrogator 500 is commercially available from Tag Sense, Inc. located in Cambridge, Mass., sold as a Micro-UHF reader.

Alternative techniques may be used to protect the IC chip 1006 on the RFID tag 1004. One example of an alternative technique is to provide protection on the RFID tag itself from the jaws 72, 74 of the apparatus. One example is disclosed in U.S. Pat. No. 7,259,678, “A Durable Radio Frequency Identification Label and Methods of Manufacturing the Same,” (Brown et. al), which provides an RFID tag having a thermoplastic guard attached to the substrate adjacent the integrated circuit to provide protection for the IC chip.

The operation of the present invention will be further described with regard to the following detailed examples. These examples are offered to further illustrate the various specific and preferred embodiments and techniques. It should be understood, however, that many variations and modifications may be made while remaining within the scope of the present invention.

A roll of UHF RFID tags was prepared according to the disclosure of U.S. patent application Ser. No. 11/870789, “RFID Tag with Modified Dipole Antenna,” (Joyce et al.) by placing the UHF RFID tags onto a three mil (0.076 mm) liner of clear polyester treated with a release agent on each side; on one side with Silox GIK and on the other side with Silox G5L, both available from Mondi Packaging, Menasha, Wis. The tags, with adhesive transfer tape placed on each side (3M™ Adhesive Transfer Tape 476MP, available from 3M Co., St. Paul, Minn.) were placed longitudinally across the width of the liner, spaced approximately one-half inch (1.27 cm) from each other, on the side of the liner with the release agent to which the adhesive on the tags held more aggressively. The function of each tag was verified, i.e. the ability to communicate with each tag, with an Impinj RFID reader model IPJ1000R (also referred to as Speedway Reader) available from Impinj, Inc., Seattle, Wash. and a Cushcraft antenna, model S9028PCRJ96RTN, available from Cushcraft Corporation, Manchester, N.H.

The roll of UHF RFID tags was placed into a 3M™ Tattle-Tape™ Application System 611, available from 3M Company, St. Paul, Minn., and thirty (30) tags were individually, sequentially applied a tag application paddle (3M part number 78-8113-6314-8) supplied with the Tattle-Tape™ Application System 611. Each tag was removed from the tag application paddle and was tested for function with the Impinj reader and Cushcraft antenna. All thirty tags failed the function test, i.e. was unable to communicate with any of the thirty tags.

The 3M tag application paddle was then modified as follows. The tag application paddle—a two part device; a molded plastic handle portion with a metal blade portion to which a tag is applied by the Tattle-Tape™ Application System 611 for insertion into a book or other object—metal blade was removed and replaced with a blade constructed of nonconductive garolite G10/FR4 available from McMaster-Carr Corporation, Chicago, Ill. A recess 0.250 inches (6.35 mm) wide by 0.875 inches (22.23 mm) long by 0.008 inches (0.02 mm) deep was machined into the surface of the garolite blade on the side opposite the handle, at a location positioned to correlate with the position of the IC chip on the UHF RFID tags. The IC chips on the tags used in this example were positioned centrally along the length of the tag.

Fifty (50) UHF RFID tags were individually, sequentially applied to the modified tag application paddle. Each tag was removed from the tag application paddle and was tested for function with the Impinj reader and Cushcraft antenna. All fifty tags functioned properly, i.e. the interrogator was able to communicate with all fifty tags.

The tests and test results described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A radio frequency identification (RFID) tag application apparatus, comprising:
a first jaw and a second jaw, wherein the first and second jaws are moveable between an open and close position;
an RFID tag positioned between the first and second jaws when the jaws are in the open position; and
an RFID tag applicator positioned between the first and second jaws, wherein the first and second jaws applies the RFID tag to the RFID tag applicator when the jaws are in the closed position,
wherein after the first and second jaws have moved between the open and closed positions to apply the RFID tag to the RFID tag applicator, the RFID tag is functional.

2. The RFID tag application apparatus of claim 1, wherein the first jaw includes a recess to provide protection to an integrated circuit of an RFID tag.

3. The RFID tag application apparatus of claim 2, wherein the second jaw includes a recess to provide protection to an integrated circuit of an RFID tag.

4. The RFID tag application apparatus of claim 1, wherein the RFID tag applicator includes a recess to provide protection to an integrated circuit of the RFID tag.

5. The RFID tag application apparatus of claims 2 or 4, wherein the RFID tag comprises a substrate, an antenna on at least one surface of the substrate, an integrated circuit electrically coupled to the antenna, and at least one adhesive layer on at least one surface of the RFID tag, wherein the adhesive layer temporarily attaches the RFID tag to the RFID tag applicator, and wherein the integrated circuit is aligned with the recess.

6. The RFID tag application apparatus of claim 1 further comprising a peel bar located adjacent the first and second jaws, wherein a plurality of RFID tags on a liner are directed around the peel bar to help separate an RFID tag from the liner.

7. The RFID tag application apparatus of claim 1 further comprising an interrogator positioned adjacent the first and second jaws for reading and/or writing information to the RFID tag.

8. An applicator for applying a radio frequency identification (RFID) tag to an item, comprising:
a handle portion;
a planar applicator portion attached to the handle portion, wherein the planar applicator portion includes a first recess on a first surface to provide protection to an integrated circuit of an RFID tag, and wherein the planar applicator portion comprises a non-conductive material.

9. The applicator of claim 8 further comprising an RFID tag, wherein the RFID tag comprises a substrate, an antenna on at least one surface of the substrate, an integrated circuit electrically coupled to the antenna, and at least one adhesive layer on at least one surface of the RFID tag, wherein the adhesive layer temporarily attaches the RFID tag to the planar portion of the applicator, and wherein the integrated circuit is aligned with the recess.

10. The applicator of claim 9, wherein the antenna is configured to operate in an ultra high frequency (UHF) band of the radio spectrum.

11. The applicator of claim 9, wherein the planar applicator portion is consisting essentially of a non-conductive material.

12. The applicator of claim 8 further comprising a second recess to provide protection to an integrated circuit of an RFID tag, wherein the second recess is located on a second surface opposite the first recess on the planar applicator portion.

13. An apparatus for removing a radio frequency identification (RFID) tag from a roll of RFID tags on a liner, comprising:
a first jaw and a second jaw, wherein the first and second jaws are moveable between an open and close position; and
an RFID tag positioned between the first and second jaws,
wherein the RFID tag comprises a substrate, an antenna on at least one surface of the substrate, an integrated circuit electrically coupled to the antenna, and at least one adhesive layer on at least one surface of the RFID tag,
wherein the first jaw includes a recess to provide protection to an integrated circuit of the RFID tag, wherein the integrated circuit of the RFID tag is aligned with the recess, and wherein after the first and second jaws have moved between the open and closed positions, the RFID tag is functional.

14. The apparatus of claim 13, further comprising:
an RFID tag applicator positioned between the first and second jaws, wherein the RFID tag applicator receives the RFID tag when the jaws are in the closed position, and wherein an adhesive layer temporarily attaches the RFID tag to the RFID tag applicator.

15. The apparatus of claim 13, wherein the second jaw includes a recess to provide protection to the integrated circuit of the RFID tag.

16. The apparatus of claim 13 further comprising a peel bar located adjacent the first and second jaws, wherein a plurality of RFID tags on a liner are directed around the peel bar to help separate an RFID tag from the liner.

17. The RFID tag application apparatus of claim 13 further comprising an interrogator positioned adjacent the first and second jaws for reading and/or writing information to the RFID tag.

18. A method for automatically removing an radio frequency identification (RFID) tag and applying the RFID tag to an RFID tag applicator, comprising the steps of:
providing a roll of RFID tags attached to a liner wherein the RFID tags comprise a substrate, an antenna on at least one surface of the substrate, an integrated circuit electrically coupled to the antenna, and at least one adhesive layer on at least one surface of the RFID tag;
providing a first jaw and a second jaw, wherein the first and second jaws are moveable between an open and close position, wherein the first jaw includes a recess to provide protection to the integrated circuit of the RFID tag (while applying the RFID tag to the RFID tag applicator);
peeling one of the RFID tags away from the liner and inserting the RFID tag between the first and second jaw while the jaws are in the open position, such that the integrated circuit of the RFID tag is aligned with the recess of the first jaw;
inserting an RFID tag applicator between the first and second jaw adjacent the RFID tag;
moving the first and second jaws the closed position to temporarily attach the RFID tag to the RFID tag applicator;
moving the first and second jaws to the open position; and
removing the RFID tag applicator with the RFID tag attached thereto, wherein the RFID tag is functional.

19. The method of claim 18, wherein the first jaw includes a recess to provide protection to the integrated circuit of the RFID tag (while applying the RFID tag to the RFID tag applicator), such that the integrated circuit of the RFID tag is aligned with the recess of the first jaw.

20. The method of claim 18, wherein the RFID tag applicator includes a recess to provide protection to the integrated circuit of the RFID tag, and the integrated circuit is aligned with the recess.

21. The method of claim 18, further comprising the step of:
inserting the RFID tag applicator and RFID tag between the pages of a book, and applying the RFID tag to one of the pages of the book.

22. The method of claim 18, further comprising the steps of:
sensing the presence of the RFID tag applicator between the first and second jaw and sensing the presence of the RFID tag between the first and second jaws prior to the step of moving the first and second jaws to the closed position.

23. The method of claim 18 further comprising the step of:
testing the integrated circuit of the RFID tag to see if it is functional, after the second moving step.

24. The method of claim 18 further comprising the step of:
reading and/or writing information to the RFID tag with an interrogator.
